(19) United States
(12) Patent Application Publication
(10) Pub. No.: US 2024/0171204 A1
(43) Pub. Date: May 23, 2024

(54) MULTILANE TRANSMITTER

(71) Applicant: REALTEK SEMICONDUCTOR CORP., Hsinchu (TW)

(72) Inventor: Tsung-Ming CHEN, Hsinchu (TW)

(73) Assignee: REALTEK SEMICONDUCTOR CORP., Hsinchu (TW)

(21) Appl. No.: 18/112,089

(22) Filed: Feb. 21, 2023

(30) Foreign Application Priority Data
Nov. 18, 2022 (TW) 111144294

(51) Int. Cl. H04B 1/04; H04B 1/408

(52) U.S. Cl. CPC H04B 1/0483; H04B 1/408

(57) ABSTRACT

A multilane transmitter includes a plurality of transmitter lane circuits and a phase lock circuit. The phase lock circuit includes an oscillating circuit. The oscillating circuit is configured to provide clock signals corresponding to the transmitter lane circuits. The oscillating circuit includes a plurality of logic units. Clock receiving terminals of the transmitter lane circuits are coupled to an output terminal of one of the plurality of logic units.

### CROSS-REFERENCE TO RELATED APPLICATION

This non-provisional application claims priority under 35 U.S.C. § 119(a) to Patent Application No. 111144294 filed in Taiwan, R.O.C. on Nov. 18, 2022, the entire contents of which are hereby incorporated by reference.

### BACKGROUND

### Technical Field

The present disclosure relates to a multilane transmitter capable of staggering power bouncing effects with an effect being free of impact of process, voltage, or temperature.

### Related Art

During toggling of an ordinary transmitter, due to pumping of a current, power bouncing may occur on a power supply of the transmitter. If the transmitter is a multilane transmitter, clock signals of transmitters may simultaneously arrive at the transmitters, causing the transmitters to toggle simultaneously, resulting in superposition of power bouncing effects. To resolve the problem of superposition of power bouncing effects in a multilane transmitter, usually, a delay unit (such as an inverter or a snubber) is configured to make times at which clock signals arrive at transmitters different, to stagger times at which power bouncing occurs on the transmitters.

However, the delay unit is affected by process, voltage, or temperature (PVT) and the like, which may make times at which clock signals arrive at transmitters worse than expected times (for example, the times at which the clock signals arrive at the transmitters are very close to each other). Consequently, superimposition of power bouncing effects produced by the transmitters still occurs, resulting in a poor effect of staggering the power bouncing effects.

### SUMMARY

In an embodiment, a multilane transmitter includes a plurality of transmitter lane circuits and a phase lock circuit. The phase lock circuit includes an oscillating circuit. The oscillating circuit is configured to provide clock signals corresponding to the transmitter lane circuits. The oscillating circuit includes a plurality of logic units. Clock receiving terminals of the transmitter lane circuits are coupled to an output terminal of one of the plurality of logic units.

In an embodiment, a multilane transmitter includes a plurality of transmitter lane circuits and a phase lock circuit. The phase lock circuit includes an oscillating circuit. The oscillating circuit is configured to provide clock signals corresponding to the transmitter lane circuits. The oscillating circuit includes a plurality of logic units. Clock receiving terminals of the transmitter lane circuits are coupled to an output terminal of one of the plurality of logic units. Distances from the clock receiving terminals of the transmitter lane circuits to the output terminal of one of the plurality of logic units to which the clock receiving terminals of the transmitter lane circuits are coupled are the same, and the phase lock circuit is arranged in the middle of the plurality of transmitter lane circuits.

In an embodiment, a multilane transmitter includes a plurality of transmitter lane circuits and a phase lock circuit. The phase lock circuit includes an oscillating circuit. The oscillating circuit is configured to provide clock signals corresponding to the transmitter lane circuits. The oscillating circuit includes a plurality of logic units. Clock receiving terminals of the transmitter lane circuits are coupled to an output terminal of one of the plurality of logic units. Distances from the clock receiving terminals of the transmitter lane circuits to the output terminal of the one of the plurality of logic units to which the clock receiving terminals of the transmitter lane circuits are coupled are the same, the phase lock circuit is arranged in the middle of the plurality of transmitter lane circuits, the plurality of logic units are differential delay units, output terminals of the logic units are coupled to a lock receiving terminal of one of the plurality of transmitter lane circuits, and clock signals of the transmitter lane circuits have fixed phases.

Detailed features and advantages of the present invention are described in detail in the following implementations, and the content of the implementations is sufficient for a person skilled in the art to understand and implement the technical content of the present invention. A person skilled in the art can easily understand the objectives and advantages related to the present invention according to the contents disclosed in this specification, the claims and the drawings.

### BRIEF DESCRIPTION OF THE DRAWINGS

FIG. 1 is a schematic block diagram of an embodiment of a multilane transmitter;

FIG. 2 is a waveform diagram of clock signals and an embodiment of power bouncing of a multilane transmitter;

FIG. 3 is a schematic block diagram of another embodiment of a multilane transmitter;

FIG. 4 is a schematic block diagram of still another embodiment of a multilane transmitter;

FIG. 5 is a schematic block diagram of an embodiment of a phase lock circuit;

FIG. 6 is a schematic block diagram of yet another embodiment of a multilane transmitter; and

FIG. 7 is a schematic block diagram of yet another embodiment of a multilane transmitter.

### DETAILED DESCRIPTION

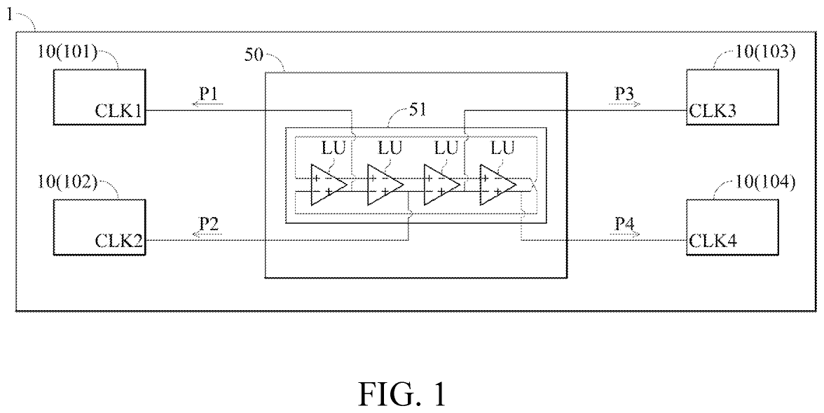

FIG. 1 is a schematic block diagram of an embodiment of a multilane transmitter 1. Referring to FIG. 1, the multilane transmitter 1 includes a plurality of transmitter lane circuits 10 and a phase lock circuit 50. The phase lock circuit 50 includes an oscillating circuit 51. The oscillating circuit 51 is configured to provide clock signals corresponding to the transmitter lane circuits 10. The oscillating circuit 51 includes a plurality of logic units LU. Clock receiving terminals of the transmitter lane circuits 10 are coupled to an output terminal of one of the plurality of logic units.

In the embodiment of FIG. 1, descriptions are provided by using an example in which the multilane transmitter 1 includes four transmitter lane circuits 10, but a quantity of the transmitter lane circuits 10 is not limited thereto. For the convenience of description, the transmitter lane circuit 10 configured to receive a clock signal P1 is referred to as a transmitter lane circuit 101. The transmitter lane circuit 101 includes a clock receiving terminal CLK1. The transmitter lane circuit 10 configured to receive a clock signal P2 is referred to as a transmitter lane circuit 102. The transmitter lane circuit 102 includes a clock receiving terminal CLK2. The transmitter lane circuit 10 configured to receive a clock signal P3 is referred to as a transmitter lane circuit 103. The transmitter lane circuit 103 includes a clock receiving terminal CLK3. The transmitter lane circuit 10 configured to receive a clock signal P4 is referred to as a transmitter lane circuit 104. The transmitter lane circuit 104 includes a clock receiving terminal CLK4.

In some embodiments, the oscillating circuit 51 may be, but is not limited to, a ring oscillator. In some embodiments, the plurality of logic units LU may be, but are not limited to, differential delay units. When the plurality of logic units LU are differential delay units, an output terminal of the logic unit LU includes a positive terminal (+) and a negative terminal (—). Therefore, regardless of whether a quantity of the plurality of logic units LU is an odd number or an even number, an output of an output terminal of the last logic unit LU of the oscillating circuit 51 can be pulled back to an input terminal of the first logic unit LU, to achieve self-oscillation. In some embodiments, a quantity of the plurality of logic units LU may be, but is not limited to, an even number. In some embodiments, output terminals of the plurality of logic units LU coupled to the clock receiving terminals of the transmitter lane circuits 10 are all positive terminals. For example, referring to FIG. 1, output terminals of the logic units LU coupled to the clock receiving terminal CLK1, the clock receiving terminal CLK2, the clock receiving terminal CLK3, and the clock receiving terminal CLK4 are all positive terminals.

In some embodiments, output terminals of the logic units LU are coupled to a clock receiving terminal of one of the plurality of transmitter lane circuits 10. In other words, the transmitter lane circuits 10 are in one-to-one connection relationships with the logic units LU. For example, referring to FIG. 1, the clock receiving terminal CLK1 of the transmitter lane circuit 101, the clock receiving terminal CLK2 of the transmitter lane circuit 102, the clock receiving terminal CLK3 of the transmitter lane circuit 103, and the clock receiving terminal CLK4 of the transmitter lane circuit 104 are all connected to only an output terminal of one logic unit LU, and the logic units LU are all connected to only one of the clock receiving terminal CLK1, the clock receiving terminal CLK2, the clock receiving terminal CLK3, or the clock receiving terminal CLK4. The transmitter lane circuit 101, the transmitter lane circuit 102, the transmitter lane circuit 103, and the transmitter lane circuit 104 are one-to-one connection relationship with the logic units LU. In some embodiments, a quantity of the plurality of logic units LU may be the same as a quantity of the plurality of transmitter lane circuit 10, but the present disclosure is not limited thereto. For example, referring to FIG. 1, both a quantity of the plurality of logic units LU and a quantity of the plurality of transmitter lane circuits 10 are four. In some embodiments, a quantity of the plurality of logic units LU may be, but is not limited to, four.

In some embodiments, clock signals corresponding to the transmitter lane circuits 10 have fixed phases. For example, when a quantity of the plurality of logic units LU is four, a fixed phase of the clock signal P1 is 90°, a fixed phase of the clock signal P2 is 180°, a fixed phase of the clock signal P3 is 270°, and a fixed phase of the clock signal P4 is 360°. That is, the clock signal P1 and the clock signal P2, the clock signal P2 and the clock signal P3, and the clock signal P3 and the clock signal P4 all have a fixed phase difference of 90°. In other words, the clock signal P1 and the clock signal P2, the clock signal P2 and the clock signal P3, and the clock signal P3 and the clock signal P4 all have a fixed and same time difference.

In some embodiments, distances from the clock receiving terminals of the transmitter lane circuits 10 to the output terminals of the logic units LU to which the clock receiving terminals of the transmitter lane circuits 10 are coupled are the same. For example, referring to FIG. 1, a distance from the clock receiving terminal CLK1 of the transmitter lane circuit 101 to an output terminal of a logic unit LU to which the clock receiving terminal CLK1 is coupled, a distance of the clock receiving terminal CLK2 of the transmitter lane circuit 102 to an output terminal of a logic unit LU to which the clock receiving terminal CLK2 is coupled, a distance of the clock receiving terminal CLK3 of the transmitter lane circuit 103 to an output terminal of a logic unit LU to which the clock receiving terminal CLK3 is coupled, and a distance of the clock receiving terminal CLK4 of the transmitter lane circuit 104 to an output terminal of a logic unit LU to which the clock receiving terminal CLK4 is coupled are all the same. In some embodiments, a circuit layout may be utilized to achieve the objective that distances from the clock receiving terminals of the transmitter lane circuits 10 to the output terminals of the logic units LU to which the clock receiving terminals of the transmitter lane circuits 10 are coupled are the same. In some embodiments, the phase lock circuit 50 may be arranged in the middle between the plurality of transmitter lane circuits 10 to achieve the objective that distances from the clock receiving terminals of the transmitter lane circuits 10 to the output terminals of the logic units LU to which the clock receiving terminals of the transmitter lane circuits 10 are coupled are the same. Specifically, the plurality of transmitter lane circuits 10 are respectively arranged on two sides, and the phase lock circuit 50 is arranged in the middle.

The clock signals P1 to P4 are provided by the plurality of logic units LU in the oscillating circuit 51, and the clock signal P1 and the clock signal P2, the clock signal P2 and the clock signal P3, and the clock signal P3 and the clock signal P4 all have a fixed and same time difference. Therefore, process, voltage, or temperature and the like may not affect times at which the clock signals P1 and P4 arrive at the transmitter lane circuits 10. In addition, if a circuit layout is utilized to make distances from the clock receiving terminals of the transmitter lane circuits 10 to the output terminals of the logic units LU to which the clock receiving terminals of the transmitter lane circuits 10 are coupled the same, times at which the clock signal P1 and the clock signal P2 arrive at the clock receiving terminals of the transmitter lane circuits 10 to which the clock signal P1 and the clock signal P2 are coupled respectively, times at which the clock signal P2 and the clock signal P3 arrive at the clock receiving terminals of the transmitter lane circuits 10 to which the clock signal P2 and the clock signal P3 are coupled respectively, and times at which the clock signal P3 and the clock signal P4 arrive at the clock receiving terminals of the transmitter lane circuits 10 to which the clock signal P3 and the clock signal P4 are coupled respectively have an expectable, fixed, and same time difference. In other words, times at which power bouncing occurs on the transmitter lane circuits 10 are staggered at a fixed time difference. That is, superposition of power bouncing effects produced by the transmitter lane circuits 10 may not occur, thereby improving the effect of staggering the power bouncing effects.

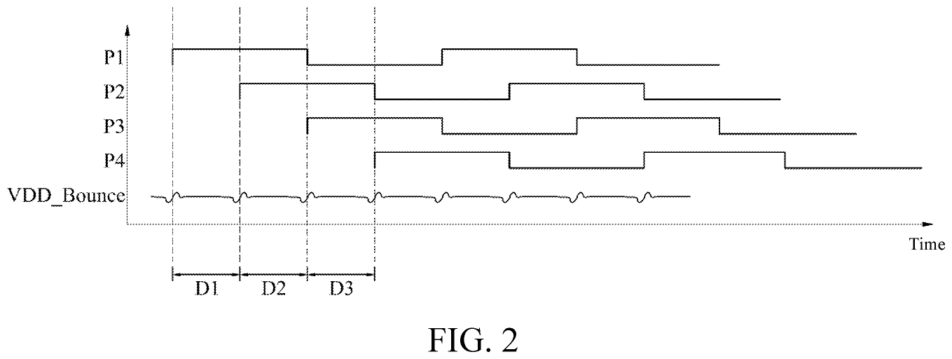

FIG. 2 is a waveform diagram of an embodiment of clock signals P1 to P4 and power bouncing VDD_bounce of a multilane transmitter 1. Referring to FIG. 2, in some embodiments, a time difference D1 between the clock signal P1 and the clock signal P2, a time difference D2 between the clock signal P2 and the clock signal P3, and a time difference D3 of the clock signal P3 and the clock signal P4 have the same value, the power bouncing VDD_bounce of the multilane transmitter 1 always occurs at positive edges of the clock signals P1 to P4. In other words, times at which the power bouncing VDD_bounce occurs on the multilane transmitter 1 are staggered by a fixed time difference, so that superposition of the power bouncing effects produced by the multilane transmitter 1 may not occur.

In some embodiments, the plurality of logic units LU may be, but are not limited to, inverters. When the plurality of logic units LU are inverters, a quantity of the plurality of logic units LU is an odd number.

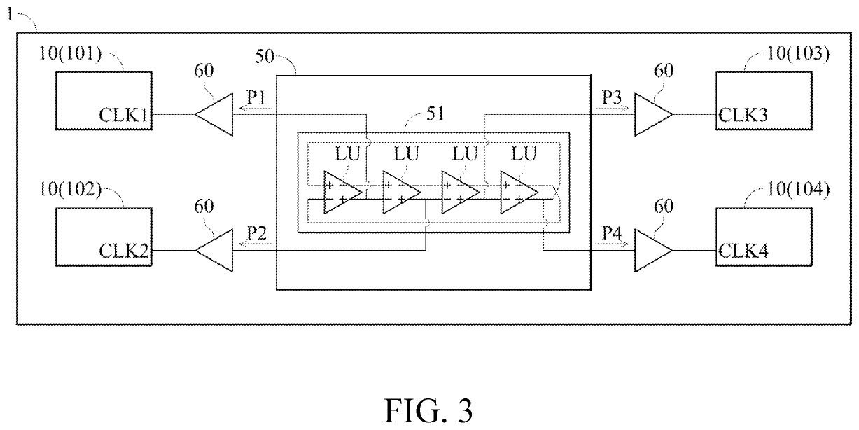

FIG. 3 is a schematic block diagram of another embodiment of the multilane transmitter 1. Referring to FIG. 3, in some embodiments, the multilane transmitter 1 further includes a plurality of snubber units 60. The plurality of snubber units 60 are coupled between the clock receiving terminals the transmitter lane circuit 10 and an output terminal of one of the plurality of logic units LU. The plurality of snubber units 60 are configured to amplify the clock signals received by the transmitter lane circuits 10. In some embodiments, the snubber unit 60 may be, but is not limited to, a snubber or an inverter. In some embodiments, a quantity of the plurality of snubber units 60 may be, but is not limited to, the quantity of the plurality of transmitter lane circuits 10. In some embodiments, a quantity of the plurality of snubber units 60 may be, but is not limited to, four.

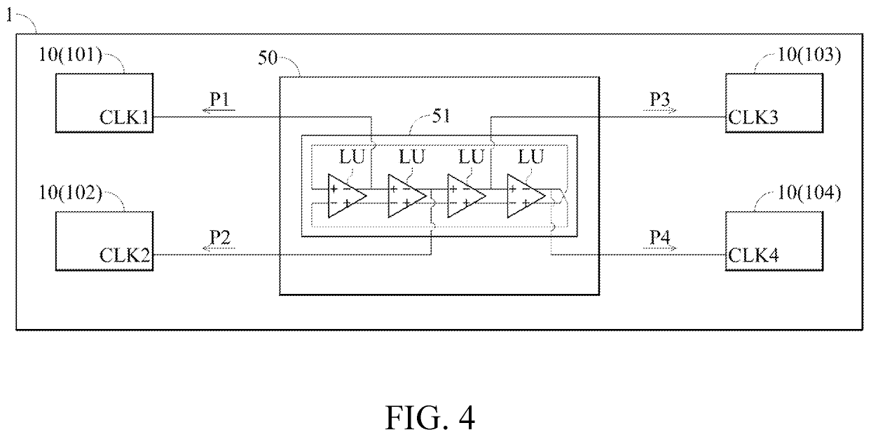

FIG. 4 is a schematic block diagram of still another embodiment of the multilane transmitter 1. Referring to FIG. 4, in some embodiments, output terminals of the plurality of logic units LU coupled to the clock receiving terminals of the transmitter lane circuits 10 are all negative terminals. For example, referring to FIG. 4, output terminals of the logic units LU coupled to the clock receiving terminal CLK1, the clock receiving terminal CLK2, the clock receiving terminal CLK3, and the clock receiving terminal CLK4 are all negative terminals.

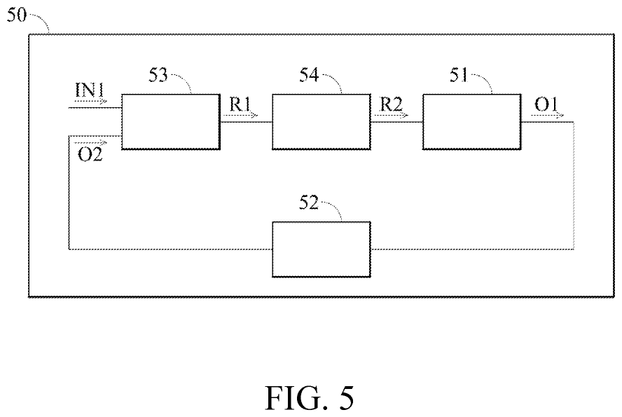

FIG. 5 is a schematic block diagram of an embodiment of the phase lock circuit 50. Referring to FIG. 5, in some embodiments, in addition to including the oscillating circuit 51, the phase lock circuit 50 further includes a frequency divider circuit 52, a phase detection circuit 53, and a filter circuit 54. The frequency divider circuit 52 is coupled to the oscillating circuit 51, and the frequency divider circuit 52 is configured to reduce a frequency of an oscillating signal O1 outputted by the oscillating circuit 51. The phase detection circuit 53 is coupled to the frequency divider circuit 52. The phase detection circuit 53 is configured to perform frequency and phase comparison on an oscillating signal O2 obtained after the frequency of the oscillating signal O1 is reduced and an input signal IN1 and output a difference representative signal R1 according to a frequency and phase comparison result of the oscillating signal O2 and the input signal IN1. The filter circuit 54 is coupled to the phase detection circuit 53 and the oscillating circuit 51. The filter circuit 54 is configured to filter the difference representative signal R1 and transmit a difference representative signal R2 obtained after the difference representative signal R1 is filtered to the oscillating circuit 51.

In some embodiments, the frequency divider circuit 52 may be, but is not limited to, a frequency divider. In some embodiments, the phase detection circuit 53 may be, but is not limited to, a phase frequency detector. In some embodiments, the filter circuit 54 may be, but is not limited to, a low-pass filter.

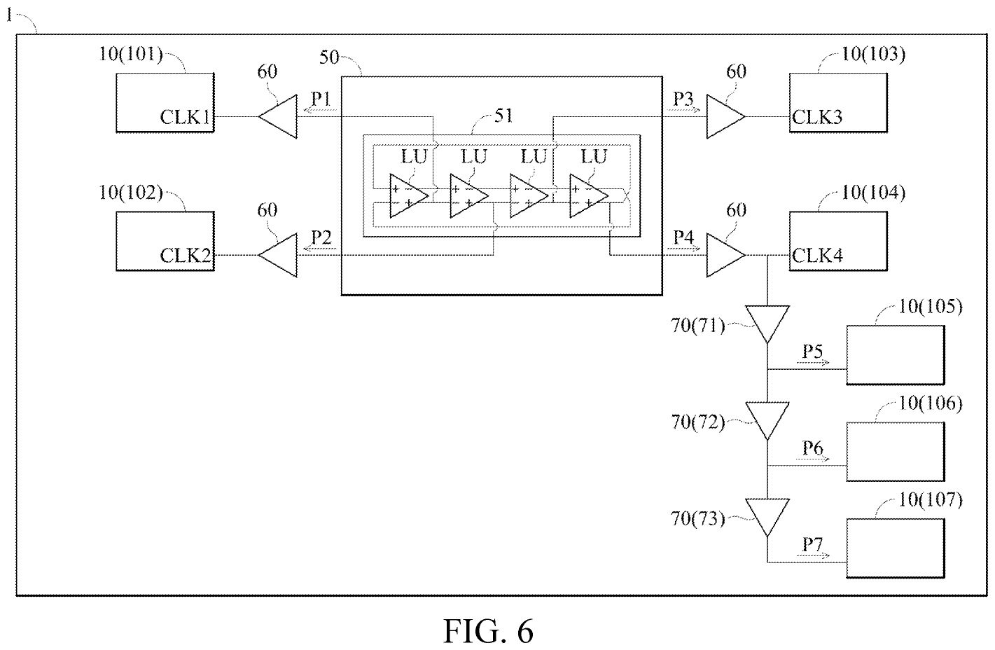

FIG. 6 is a schematic block diagram of yet another embodiment of the multilane transmitter 1. Referring to FIG. 6, in some embodiments, the multilane transmitter 1 further includes a plurality of delay units 70. In some embodiments, a quantity of the plurality of logic units LU may be less than a quantity of the plurality of transmitter lane circuits 10, but the present disclosure is not limited thereto. When the quantity of the plurality of logic units LU is less than the quantity of the plurality of transmitter lane circuits 10, the plurality of delay units 70 may be configured to stagger plurality of times at which power bouncing occurs on the transmitter lane circuits 10.

In the embodiment of FIG. 6, descriptions are provided by using an example in which the multilane transmitter 1 includes three delay units 70, but a quantity of the delay units 70 is not limited thereto. For the convenience of description, the three delay units 70 are respectively referred to as a delay unit 71, a delay unit 72, and a delay unit 73.

For example, referring to FIG. 6, a transmitter lane circuit 105, a transmitter lane circuit 106, and a transmitter lane circuit 107 are transmitter lane circuits 10 that exceed the quantity of the plurality of logic units LU. The delay unit 71 is coupled to the transmitter lane circuit 105 and an output terminal of a logic unit LU providing the clock signal P4, the delay unit 72 is coupled to the delay unit 71 and the transmitter lane circuit 106, and the delay unit 73 is coupled to the delay unit 72 and the transmitter lane circuit 107. Due to the delay unit 71, a time at which the clock signal P1 arrives at the transmitter lane circuit 105 is later than a time at which the clock signal P4 arrives at the transmitter lane circuit 104. Due to the delay unit 72, a time at which a clock signal P6 arrives at the transmitter lane circuit 106 is later than a time at which a clock signal P5 arrives at the transmitter lane circuit 105. Due to the delay unit 73, a time at which a clock signal P7 arrives at the transmitter lane circuit 107 is later than a time at which a clock signal P6 arrives at the transmitter lane circuit 106. The adoption of the plurality of delay units 70 makes the times at which the clock signals arrive at the transmitter lane circuit 104, the transmitter lane circuit 105, the transmitter lane circuit 106, and the transmitter lane circuit 107 different, to stagger times at which power bouncing occurs on the transmitter lane circuits 10.

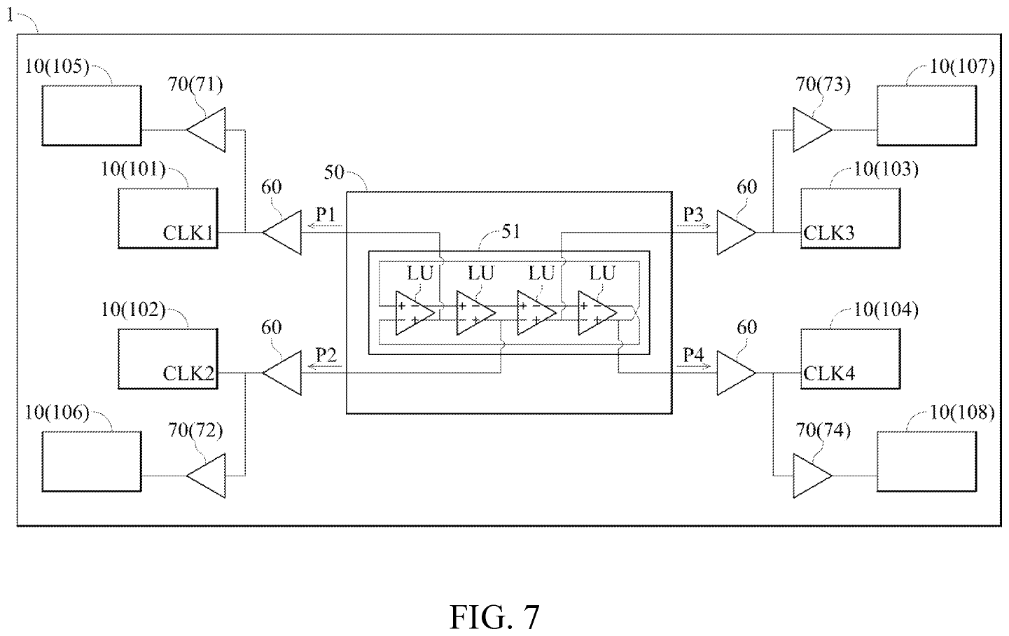

FIG. 7 is a schematic block diagram of yet another embodiment of the multilane transmitter 1. Referring to FIG. 7, in some embodiments, a plurality of delay units 70 are individually coupled to an output terminal of one of the plurality of logic units LU and one of the plurality of transmitter lane circuits 10.

In the embodiment of FIG. 7, descriptions are provided by using an example in which the multilane transmitter 1 includes four delay units 70, but a quantity of the delay units 70 is not limited thereto. For the convenience of description, the four delay units 70 are respectively referred to as a delay unit 71, a delay unit 72, a delay unit 73, and a delay unit 74.

For example, referring to FIG. 7, a transmitter lane circuit 105, a transmitter lane circuit 106, a transmitter lane circuit 107, and a transmitter lane circuit 108 are transmitter lane circuits 10 that exceed the quantity of the plurality of logic units LU. The delay unit 71 is coupled to the transmitter lane circuit 105 and an output terminal of a logic unit LU providing the clock signal P1, the delay unit 72 is coupled to the transmitter lane circuit 106 and an output terminal of a logic unit LU providing the clock signal P2, the delay unit 73 is coupled to the transmitter lane circuit 107 and an output terminal of a logic unit LU providing the clock signal P3, and the delay unit 74 is coupled to the transmitter lane circuit 108 and an output terminal of a logic unit LU providing the clock signal P4. Due to the delay unit 71, a time at which the clock signal P1 arrives at the transmitter lane circuit 105 is later than a time at which the clock signal P1 arrives at the transmitter lane circuit 101. Due to the delay unit 72, a time at which the clock signal P2 arrives at the transmitter lane circuit 106 is later than a time at which the clock signal P2 arrives at the transmitter lane circuit 102. Due to the delay unit 73, a time at which the clock signal P3 arrives at the transmitter lane circuit 107 is later than a time at which the clock signal P3 arrives at the transmitter lane circuit 103. Due to the delay unit 74, a time at which the clock signal P4 arrives at the transmitter lane circuit 108 is later than a time at which the clock signal P4 arrives at the transmitter lane circuit 104. The adoption of the plurality of delay units 70 makes the times at which the clock signals arrive at the transmitter lane circuit 104, the transmitter lane circuit 105, the transmitter lane circuit 106, the transmitter lane circuit 107, and the transmitter lane circuit 108 different, to stagger times at which power bouncing occurs on the transmitter lane circuits 10.

In some embodiments, the delay unit 70 may be, but is not limited to, an inverter or a snubber. In some embodiments, a quantity of the plurality of delay units 70 may be a quantity of the plurality of transmitter lane circuits 10 minus a quantity of the plurality of logic units LU.

In conclusion, in some embodiments, clock signals of the plurality of transmitter lane circuits 10 are provided by the plurality of logic units LU inside the oscillating circuit 51. Therefore, process, voltage, or temperature and the like may not affect times at which the clock signals arrive at the transmitter lane circuits 10. In addition, if a circuit layout is utilized to make distances from the clock receiving terminals of the transmitter lane circuits 10 to the output terminals of the logic units LU to which the clock receiving terminals of the transmitter lane circuits 10 are coupled the same, times at which the clock signals arrive at the transmitter lane circuits 10 have an expectable, fixed, and same time difference, so that times at which power bouncing occurs on the transmitter lane circuits 10 are staggered by a fixed time difference, thereby preventing superposition of power bouncing effects produced by the transmitter lane circuits 10 from occurring and improving the effect of staggering the power bouncing effects.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A multilane transmitter, comprising:
a plurality of transmitter lane circuits; and
a phase lock circuit, comprising an oscillating circuit, wherein the oscillating circuit is configured to provide one clock signal corresponding to the transmitter lane circuits, the oscillating circuit comprises a plurality of logic units, one clock receiving terminal of the transmitter lane circuits is coupled to an output terminal of one of the logic units.

2. The multilane transmitter according to claim 1, wherein the logic units are differential delay units.

3. The multilane transmitter according to claim 1, wherein the logic units are inverters.

4. The multilane transmitter according to claim 2, wherein output terminals of the logic units are coupled to the clock receiving terminal of one of the transmitter lane circuits.

5. The multilane transmitter according to claim 4, wherein the clock signals corresponding to the transmitter lane circuits have a fixed phase.

6. The multilane transmitter according to claim 5, wherein a quantity of logic units is the same as a quantity of the transmitter lane circuits.

7. The multilane transmitter according to claim 6, wherein distances from the clock receiving terminals of the transmitter lane circuits the output terminals of the logic units to which the clock receiving terminals are coupled are the same.

8. The multilane transmitter according to claim 7, wherein the phase lock circuit is arranged in the middle between the transmitter lane circuits.

9. The multilane transmitter according to claim 8, wherein a quantity of the transmitter lane circuits is four.

10. The multilane transmitter according to claim 9, further comprising:
a plurality of snubber units, coupled to the clock receiving terminals of the transmitter lane circuits and an output terminal of one of the logic units, and configured to amplify the clock signal.

11. The multilane transmitter according to claim 8, wherein the phase lock circuit further comprises:
a frequency divider circuit, coupled to the oscillating circuit, and configured to reduce a frequency of an oscillating signal outputted by the oscillating circuit;
a phase detection circuit, coupled to the frequency divider circuit, and configured to perform frequency and phase comparison on the frequency-reduced oscillating signal and an input signal and output a difference representative signal according to a frequency and phase comparison result of the frequency-reduced oscillating signal and the input signal; and
a filter circuit, coupled to the phase detection circuit and the oscillating circuit, and configured to filter the difference representative signal and transmit the filtered difference representative signal to the oscillating circuit.
